(19) United States
(12) Patent Application Publication
(10) Pub. No.: US 2009/0127275 A1
(43) Pub. Date: May 21, 2009

(54) APPARATUS AND METHOD FOR SUPPORTING TAKING MEDICINE

(76) Inventors: Jae Hun CHOI, Daejeon (KR); Soo Jun PARK, Seoul (KR); Seon Hee PARK, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/191,573

(22) Filed: Aug. 14, 2008

(30) Foreign Application Priority Data
Nov. 20, 2007 (KR) 10-2007-0118370

(51) Int. Cl. G07F 11/62; G06F 17/00

(52) U.S. Cl. 221/1; 221/6; 221/9; 700/240

(57) ABSTRACT

An apparatus for supporting taking medicine includes a medicine storage unit which has a plurality of medicine storage holes to store therein medicines to be taken by a user, a sensor controller which determines whether the medicine storage holes include medicines therein, and a medicine taking service unit which receives a preset schedule by synchronizing with a personal computer, checks whether a user has taken medicine according to a determination of the sensor controller and informs a user to take a medicine according to the preset schedule. Thus, users who should take various medicines on a regular basis for daily life may observe the medicine taking time.

### CROSS-REFERENCE TO RELATED APPLICATIONS

This application claims the priority of Korean Patent Application No. 10-2007-118370, filed on Nov. 20, 2007, in the Korean Intellectual Property Office, the disclosure of which is incorporated herein by reference.

### BACKGROUND OF THE INVENTION

1. Field of the Invention

The present invention relates to an apparatus and a method for supporting taking medicine as one of applications of U-health care, and more particularly, to an apparatus and a method for supporting taking medicine which supports a user taking various medicines regularly for daily life to observe medicine-taking time.

The present invention was supported by the IT R&D program of MIC/IITA[2006-S-007-02, Ubiquitous Health Monitoring Module and System Development].

2. Description of the Related Art

Users such as the elderly suffering from chronic diseases should take various medicines for daily life. However, such users may feel difficult when to take which medicine and may forget to take medicine sometimes.

Such users should observe medicine-taking time according to prescriptions for quick recovery, and an apparatus which supports users to observe the medicine-taking time includes a clock and a medicine box having an alarm device. If a user sets time of the clock and the alarm device to take medicine, the clock and the medicine box having the alarm device generate sound or vibration at the preset time to inform a user of the medicine-taking time. Then, a user may stop the alarm and take medicine to thereby observe the medicine-taking time. Other various types of devices including a device preparing medicine automatically at medicine-taking time have been recently developed to support a user taking medicine.

However, such devices only set single medicine-taking time. Thus, a user should set each medicine-taking time, and the seniors or children may hardly know what to take among various medicines from a medicine box.

Moreover, the devices only indicate the medicine-taking time, and do not determine whether a user has taken medicine after the notice.

### SUMMARY OF THE INVENTION

The present invention has been made to solve the foregoing problems with the prior art, and therefore (an aspect/object of) the present invention is to provide an apparatus and a method for supporting taking medicine which sets medicine-taking time for a single day at a time and provides medicine to be taken by a user.

Also, the present invention is to provide an apparatus and a method for supporting taking medicine which automatically detects that a user has not taken medicine at medicine-taking time and encourages a user to take medicine.

According to an aspect of the present invention, an apparatus for supporting taking medicine includes a medicine storage unit which has a plurality of medicine storage holes to store therein medicines to be taken by a user; a sensor controller which determines whether the medicine storage holes include medicines therein; and a medicine taking service unit which receives a preset schedule by synchronizing with a personal computer, checks whether a user has taken medicine according to a determination of the sensor controller and informs a user to take a medicine according to the preset schedule.

According to another aspect of the present invention, an apparatus for supporting taking medicine includes a medicine storage unit which has a plurality of medicine storage holes to store therein medicines to be taken by a user; a sensor controller which determines whether the medicine storage holes include medicines therein; a wireless communication unit to wirelessly communicate with a personal computer, the medicine storage unit, the sensor controller and the wireless communication unit provided in a medicine box; and a medicine taking service unit which sets a schedule through a user's input in advance, receives a result from the sensor controller through the wireless communication unit, determines whether a user has taken medicine according to the received result and informs a user to take medicine according to the preset schedule, the medicine taking service unit provided separately from the medicine box.

According to a further aspect of the present invention, a method for supporting taking medicine of an apparatus for supporting taking medicine includes receiving a preset schedule from a personal computer by synchronizing with the personal computer; initializing a state of medicine storage holes if the schedule is received; and performing a medicine service according to the schedule and the state of the medicine storage holes.

As set forth above, the apparatus and method for supporting taking medicine according to the present invention is very portable, sets medicine-taking time for a single day at a time, indicates medicine-taking time, medicine untaken, subsequent medicine to be taken to users and allows users including the elderly suffering from chronic diseases to take medicine anytime anywhere.

### BRIEF DESCRIPTION OF THE DRAWINGS

FIG. 1 is a block diagram of a smart device for supporting taking medicine according to a first exemplary embodiment of the present invention;

FIG. 2 is a block diagram of a smart device for supporting taking medicine according to a second exemplary embodiment of the present invention;

FIG. 3 illustrates processes of supporting taking medicine from the smart device according to the exemplary embodiments of the present invention;

FIG. 4 illustrates processes of supporting taking medicine from the smart device according to the exemplary embodiments of the present invention;

FIG. 5 is a flowchart to describe a synchronization process to support taking medicine from an apparatus for supporting taking medicine according to the exemplary embodiments of the present invention;

FIG. 6 is a flowchart to describe an initialization process from the apparatus for supporting taking medicine according to the exemplary embodiments of the present invention;

FIG. 7 is a flowchart to describe a process of supporting taking medicine from the apparatus for supporting taking medicine according to the exemplary embodiments of the present invention; and

FIGS. 8A and 8B illustrate an example of a schedule and determination of a state according to the exemplary embodiments of the present invention.

### DETAILED DESCRIPTION OF THE PREFERRED EMBODIMENT

Reference will now be made in detail to the embodiments of the present invention, examples of which are illustrated in the accompanying drawing, wherein like reference numerals refer to like elements throughout. The embodiments are described below so as to explain the present invention by referring to the figures.

An apparatus and a method for supporting taking medicine which supports users taking various medicines on a regular basis will be described according to exemplary embodiments of the present invention. An apparatus for supporting taking medicine may be employed in a portable device such as a smart portable device. Hereinafter, the configuration of the apparatus for supporting taking medicine will be described in detail with reference to drawings.

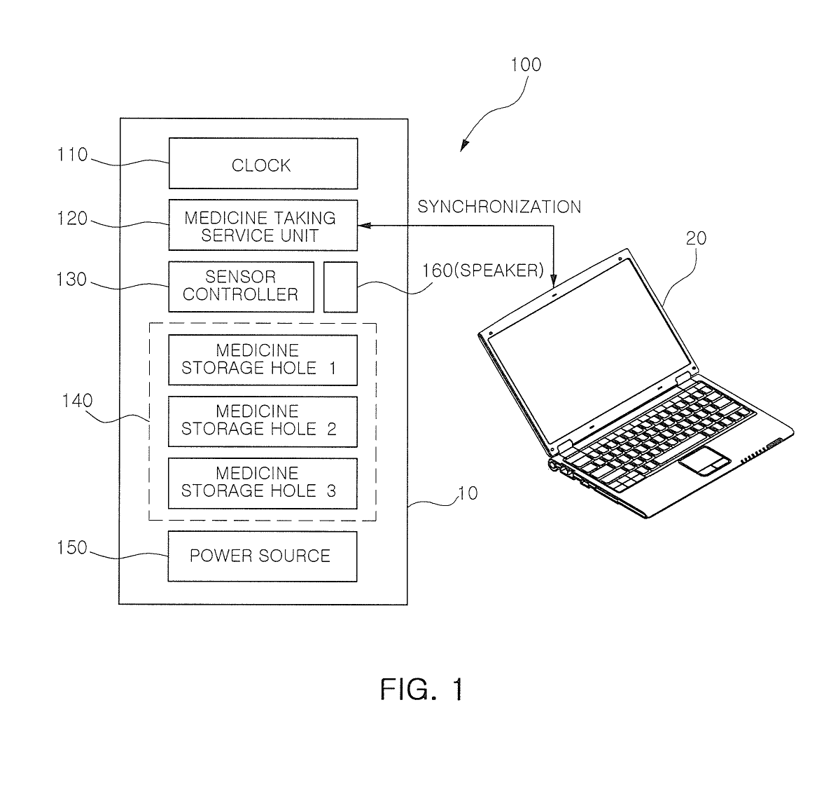

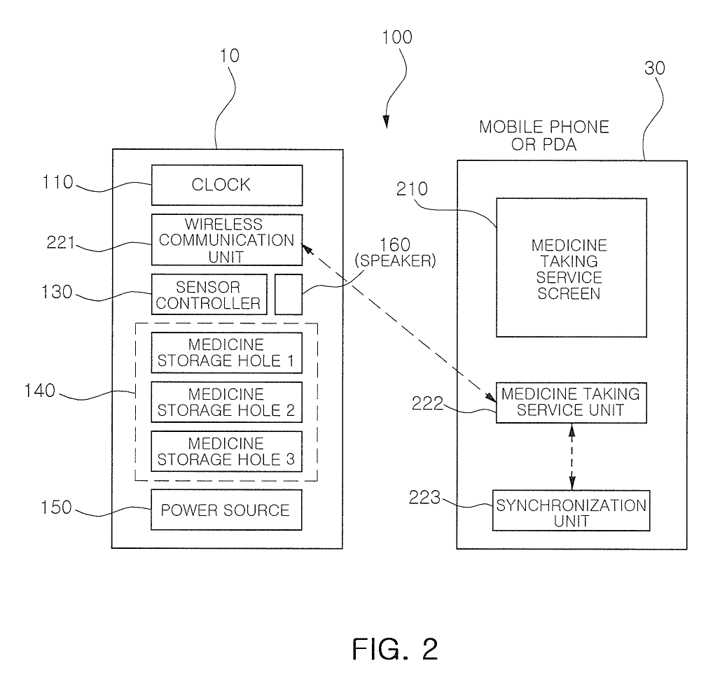

FIG. 1 is a block diagram of a smart device for supporting taking medicine according to a first exemplary embodiment of the present invention. FIG. 2 is a block diagram of a smart device for supporting taking medicine according to a second exemplary embodiment of the present invention.

Referring to FIG. 1, in an apparatus for supporting taking medicine 100 according to a first exemplary embodiment of the present invention, a medicine box 10 and a personal computer (hereinafter, referred to as PC) 20 wirelessly communicate with each other to support taking medicine. The apparatus for supporting taking medicine 100 may include a clock 110, a medicine taking service unit 120, a sensor controller 130, a medicine storage unit 140, a power source 150 and a speaker 160.

The clock 110 displays current time and medicine-taking time. The medicine-taking time may be set only once or set at a time for a single day.

The medicine taking service unit 120 determines a situation of a user, i.e., an input of a medicine-taking schedule, an initialization of the apparatus, an indication of taking medicine and a state of a user taking medicine. The medicine taking service unit 120 wirelessly communicates with the PC 20 and receives a medicine-taking schedule of a user, i.e., medicine-taking time for one day from the PC 20 and performs synchronization. The synchronization may be performed by a synchronization module of the PC 20.

The sensor controller 130 adjusts the current time and the state of the sensors formed in the medicine storage unit 140, and determines whether the medicine storage unit 140 stores medicines therein according to a detection result of the sensors.

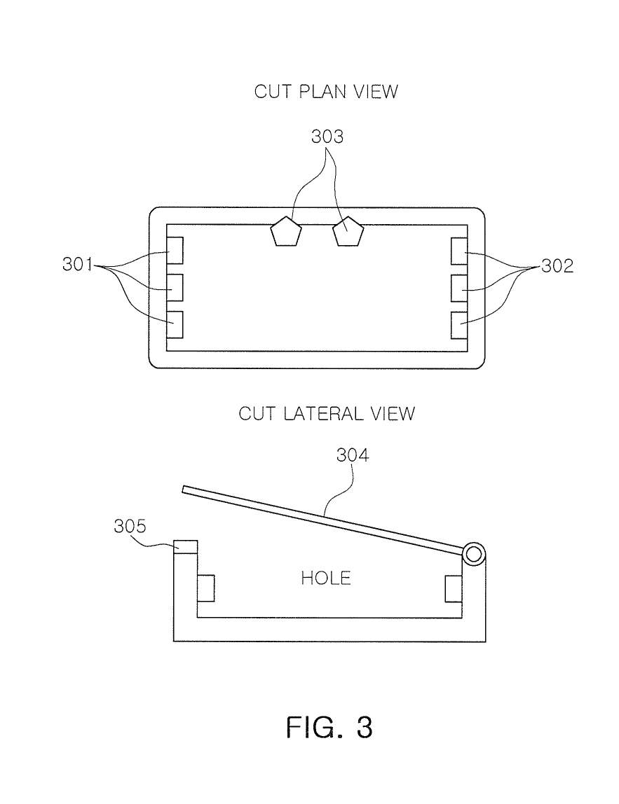

The medicine storage unit 140 includes a plurality of medicine storage holes to store therein medicines to be taken by a user, a plurality of infrared sensors and a plurality of light emitting diodes (LEDs). As shown in (a) in FIG. 3, each of the medicine storage holes may include a plurality of infrared ray generating sensors 301 and a plurality of infrared ray receiving sensors 302 which are formed on opposite lateral sides and face each other, and a light emitting diode (LED) 303 in another lateral side. As shown in (b) in FIG. 2, each of the medicine storage holes includes a hole cover 304 formed thereon and a contact sensor 305 detecting an opening and a closing of the hole cover 304.

The infrared ray generating sensors 301 and the infrared ray receiving sensors 302 detect whether the medicine storage holes have medicines therein. That is, if infrared rays generated by the infrared ray generating sensors 301 reach the infrared ray receiving sensors 302, it is determined that medicines are not stored in the medicine storage holes. If any one of the generated infrared rays is not received, it is determined that the medicines are stored in the medicine storage holes. The number of the infrared ray generating sensors 301 and the infrared ray receiving sensors 302 may be determined depending on the size of the medicine storage holes. For example, if an interval between the sensors is wide, small medicines may be disposed between the sensors, which may lower the detection rate. The LED 303 indicates that medicine to be taken by a user exists.

The speaker 160 generates an alarm to encourage a user to take medicine if receiving an alarming signal from the medicine taking service unit 120 at the medicine-taking time set by a user.

An apparatus for supporting taking medicine according to a second exemplary embodiment of the present invention may include a portable device such as a mobile phone and a PDA, a configuration of which is as shown in FIG. 2.

Referring to FIG. 2, an apparatus for supporting taking medicine 200 according to the second exemplary embodiment of the present invention may include a medicine box 10 and a portable device 30 such as a mobile phone and a PDA.

The apparatus for supporting taking medicine 200 is the same as that according to the first exemplary embodiment of the present invention except the medicine taking service unit 120. Wireless communication and initialization functions of the medicine taking service unit 120 are provided by a separate module. That is, a wireless communication unit 221 is provided in the medicine box 10 while a medicine taking service unit 222 and a synchronization unit 223 are provided in the portable device 30. The wireless communication unit 221 transmits information about the medicine box 10 to the medicine taking service unit 222 with respect to the medicine-taking service while the synchronization unit 223 receives and transmits medicine-taking information with respect to the medicine taking service unit 222.

The apparatus for supporting taking medicine 200 displays a medicine-taking schedule, a medicine-taking mode and information about the medicine box 10 through a medicine taking service screen 210 of the portable device 30.

Operations of elements of the apparatus for supporting taking medicine 200 are the same as those of the apparatus for supporting taking medicine 100 according to the first exemplary embodiment of the present invention. Thus, detailed descriptions will be omitted.

A method for supporting taking medicine of the apparatus for supporting taking medicine according to the exemplary embodiments of the present inventions will be described with reference to drawings.

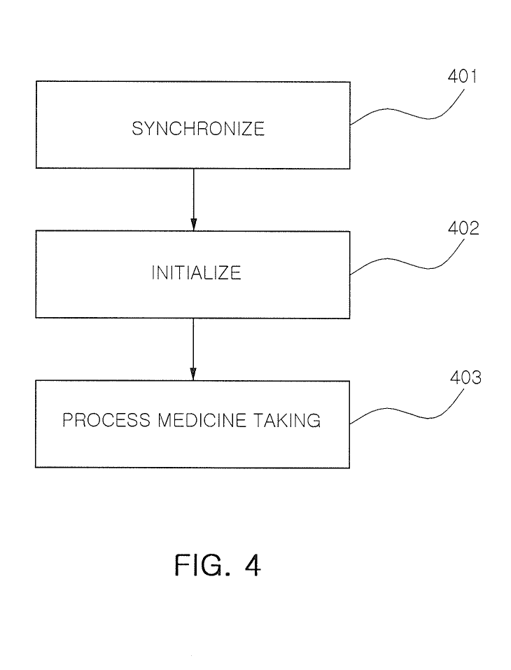

381 As shown in FIG. 4, a process of supporting taking medicine may include an operation of synchronizing S401, an operation of initializing S402 and an operation of processing taking medicine S403. The operations will be described in detail.

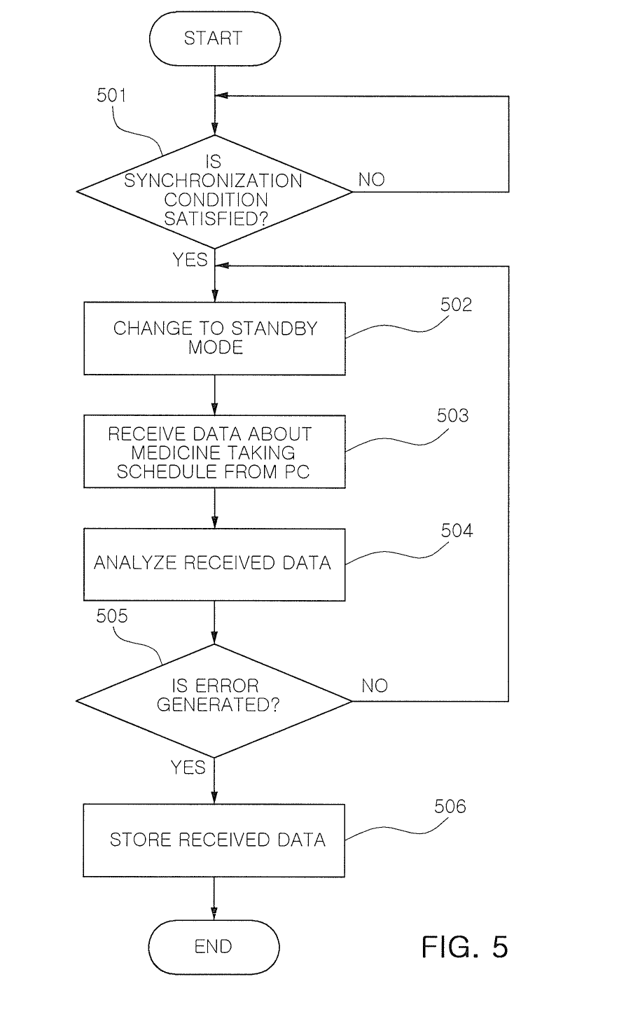

FIG. 5 is a flowchart to describe a synchronization process to support taking medicine of the apparatus for supporting taking medicine according to the exemplary embodiments of the present invention.

The apparatus for supporting taking medicine receives a medicine-taking schedule of a user from the PC 20 and performs synchronization S401 if the synchronization condition is satisfied. The synchronization condition includes a physical connection of the PC 20 through a USB and discrepancy between the date of the medicine-taking schedule of the apparatus and a date of the clock.

Referring to FIG. 5, the apparatus for supporting taking medicine determines whether the synchronization condition is satisfied at operation S501, and changes into a standby mode at operation S502 if the synchronization condition is satisfied.

At operation S503, the apparatus for supporting taking medicine receives data about the medicine-taking schedule from the PC 20 and analyzes the received data at operation S504. At operation S505, the apparatus for supporting taking medicine determines through the analyzed result whether an error is generated. If the error is generated, the apparatus for supporting taking medicine requests the medicine-taking schedule to the PC 20 and performs the operation S503 again. If the error is not generated, the apparatus for supporting taking medicine stores the received data at operation S506.

After performing the synchronization S401, the apparatus for supporting taking medicine performs the initialization S402 if the initialization condition is satisfied. The initialization condition includes a first operation of the apparatus, synchronization, the closing of the hole cover 304 of the medicine storage holes or pressing of an initialization button depending on apparatuses.

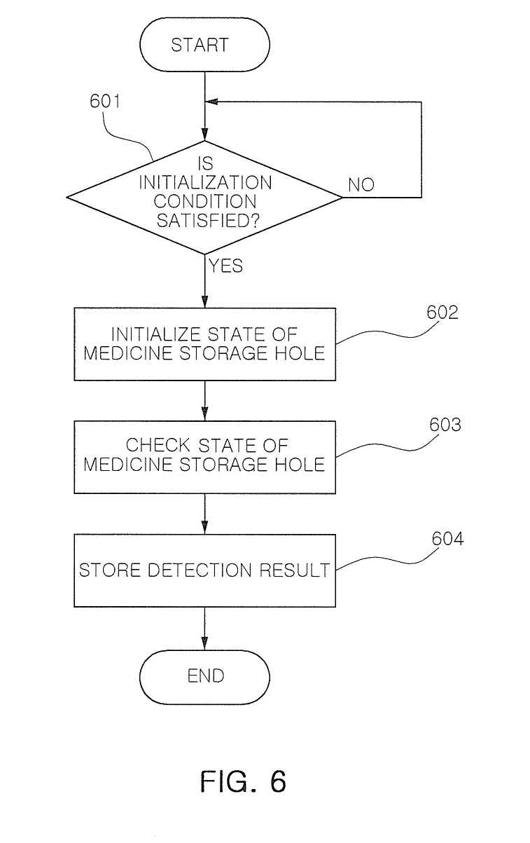

FIG. 6 is a flowchart to describe an initialization process from the apparatus for supporting taking medicine according to the exemplary embodiments of the present invention.

Referring to FIG. 6, the apparatus for supporting taking medicine determines whether the initialization condition is satisfied at operation S601. If the initialization condition is satisfied, the apparatus for supporting taking medicine sets the state of the medicine storage holes of the medicine storage unit 140 into an initialization mode, i.e., sets the state of the LED 303 of the medicine storage holes into an OFF state and sets the state of the medicine storage holes not having medicine therein, into an EMPTY mode at operation S602.

At operation S603, the apparatus for supporting taking medicine detects whether a medicine exists in the medicine storage holes through the infrared ray generating sensors 301 and the infrared ray receiving sensors 302 according to a control of the sensor controller 130, and check the state of the medicine storage holes through the detection result of the sensor controller 130.

At operation S604, the apparatus for supporting taking medicine stores information about the detection result of the sensor controller 130, i.e., the information about the state of the medicine storage holes. The information about the state of the medicine storage holes is used during the processing of taking medicine S403.

After performing the initialization S402, the apparatus for supporting taking medicine performs the processing of taking medicine S403 in which an indication of taking medicine, indication of medicine not taken and an indication of subsequent medicine to be taken are performed.

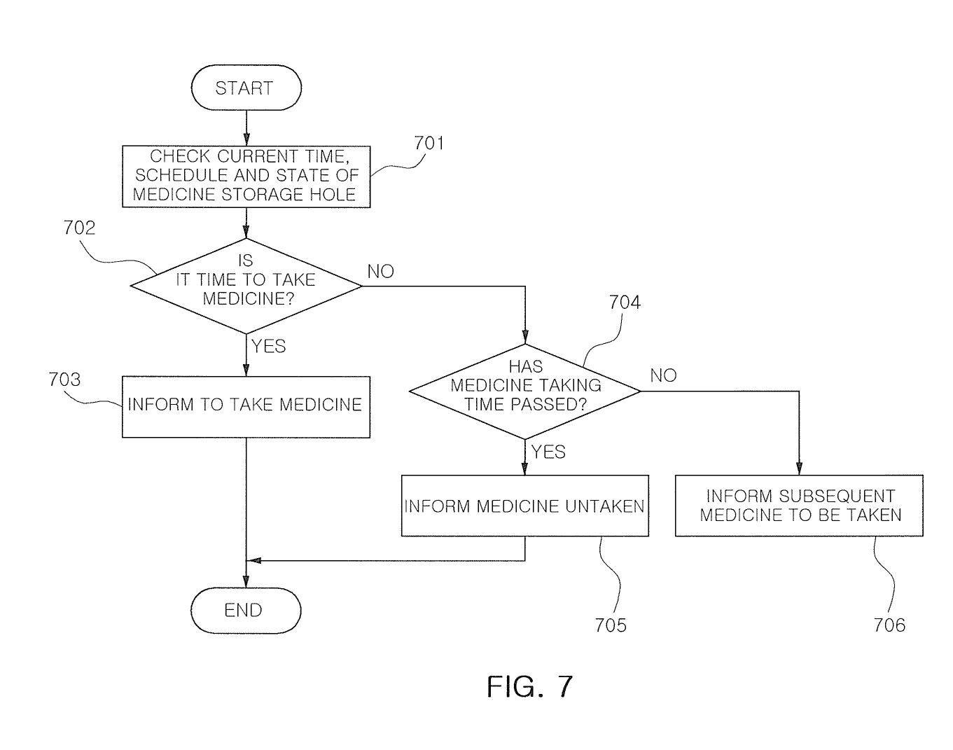

FIG. 7 is a flowchart to describe a processing of taking medicine from the apparatus for supporting taking medicine according to the exemplary embodiments of the present invention.

Referring to FIG. 7, at operation S701, the apparatus for supporting taking medicine check current time, a current time from the schedule and the state of the medicine storage holes. At operation S702, the apparatus for supporting taking medicine determines whether it is time to take medicine according to the determination result. If it is determined that it is time to take medicine, the apparatus for supporting taking medicine informs a user that it is time to take medicine at operation S703. If it is determined that it is not time to take medicine, the apparatus for supporting taking medicine determines whether the detection result indicates the passing of the medicine-taking time at operation S704. If it is determined that the medicine-taking time has passed, the apparatus for supporting taking medicine informs a user that the medicine has not taken at operation S705. If it is determined that the medicine-taking time has not passed, the apparatus for supporting taking medicine informs a user of a subsequent medicine to be taken at operation S706.

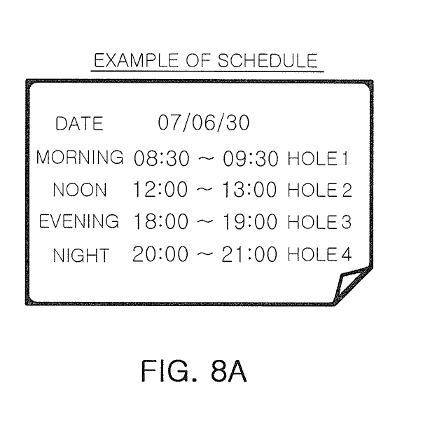

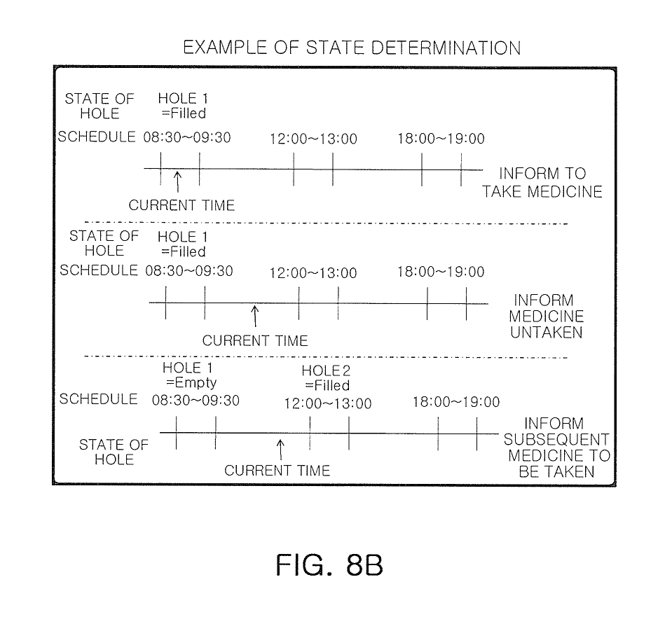

Examples of determining the current state and the schedule in the processing of taking medicine will be described with reference to FIGS. 8A and 8B.

Referring to FIG. 8A, for example, the schedule includes a first medicine taking timing, i.e., morning (08:30˜09:30) for a first medicine storage hole, a second medicine-taking timing, i.e., noon (12:00˜13:00) for a second medicine storage hole, a third medicine-taking timing, i.e., evening (18:00˜19:00) for a third medicine storage hole and a fourth medicine-taking timing, i.e., night (20:00˜21:00) for a fourth medicine storage hole. An example of determining the current state with the schedule will be described.

Referring to FIG. 8B, if the current time is included in the first medicine-taking timing (08:30˜09:30) and the first medicine storage hole is filled, the current state refers to a timing to take a medicine of the first medicine storage hole. After determining that it is time to take medicine, the apparatus for supporting taking medicine informs a user that it is time to take medicine through the speaker 160 or the LED 303 of the first medicine storage hole.

If current time is included in the timing of 09:30˜12:00 between the first and second medicine-taking timings and if the first medicine storage hole is filled, the current state refers to a timing that a user has not taken medicine of the first medicine storage hole yet. Thus, the apparatus for supporting taking medicine determines that the medicine of the first medicine storage hole is not taken, and informs a user of that through the speaker 160 or the LED 303 of the first medicine storage hole.

If current time is included in the timing of 09:30˜12:00 between the first and second medicine-taking timings and if the first medicine storage hole is empty and the second medicine storage hole is filled, the current state refers that a user has taken the medicine of the first medicine storage hole and should take medicine of the second medicine storage hole for next timing. Thus, the apparatus for supporting taking medicine determines that the medicine of the second medicine storage hole should be taken at the next second medicine-taking timing and informs a user of that through the speaker 160 or the LED 303 of the first medicine storage hole.

Although a few exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. An apparatus for supporting taking medicine, the apparatus comprising:
a medicine storage unit which has a plurality of medicine storage holes to store therein medicines' to be taken by a user,
a sensor controller which determines whether the medicine storage holes include medicines therein; and
a medicine taking service unit which receives a preset schedule by synchronizing with a personal computer, checks whether a user has taken the medicines according to a determination of the sensor controller, and informs a user to take the medicines according to the preset schedule.

2. The apparatus according to claim 1, wherein the medicine storage unit comprises:
a plurality of infrared ray generating sensors which generates an infrared signal,
a plurality of infrared ray receiving sensors which detects the generated infrared signal,
a light emitting diode (LED) which informs a user of medicines to be taken, and
a plurality of medicine storage holes which has a contact sensor to detect an opening and a closing of a cover.

3. The apparatus according to claim 2, wherein the sensor controller determines that the medicines to be taken by a user exist if at least one of the infrared signals generated by the infrared ray generating sensors is detected.

4. The apparatus according to claim 2, wherein the sensor controller sets a state of the medicine storage holes into an EMPTY mode if an initialization condition is satisfied, and determines that the medicines to be taken do not exist if any of the infrared signals is not detected.

5. The apparatus according to claim 4, wherein the medicine taking service unit determines that it is time for a user to take medicine if current time is included in a medicine-taking timing from the schedule and the concerned storage hole has the medicine therein.

6. The apparatus according to claim 4, wherein the medicine taking service unit determines that a user has not taken medicine if the current time is included between the medicine-taking timings from the schedule and the concerned storage hole has the medicine therein.

7. The apparatus according to claim 5, wherein the medicine taking service unit determines that a user should take medicines at a next medicine-taking timing if the current time is included between the medicine-taking timings from the schedule and the concerned storage hole does not have the medicine therein.

8. The apparatus according to claim 6, wherein the medicine taking service unit generates an alarm through a speaker to inform a user of the medicine-taking timing.

9. An apparatus for supporting taking medicine, the apparatus comprising:
a medicine storage unit which has a plurality of medicine storage holes to store therein medicines to be taken by a user,
a sensor controller which determines whether the medicine storage holes include medicines therein;
a wireless communication unit which wirelessly communicates with a personal computer; and
a medicine taking service unit which sets a schedule through a user's input in advance, receives a detection result from the sensor controller through the wireless communication unit, determines whether a user has taken the medicines according to the received result and informs a user to take the medicines according to the preset schedule,
wherein the medicine storage unit, the sensor controller and the wireless communication unit are provided in a medicine box, and the medicine taking service unit is provided separately.

10. The apparatus according to claim 9, further comprising:
a synchronization unit which transmits synchronization data to the medicine taking service unit to synchronize with the medicine box.

11. The apparatus according to claim 9, wherein the medicine storage unit comprises:
a plurality of infrared ray generating sensors which generates an infrared signal,
a plurality of infrared ray receiving sensors which detects the generated infrared signal,
a light emitting diode (LED) which informs a user of medicines to be taken, and
a plurality of medicine storage holes which has a contact sensor to detect an opening and a closing of a cover.

12. The apparatus according to claim 11, wherein the sensor controller determines that the medicines to be taken by a user exist if at least one of the infrared signals generated by the infrared ray generating sensors is detected.

13. The apparatus according to claim 11, wherein the sensor controller sets a state of the medicine storage holes into an EMPTY mode if an initialization condition is satisfied, and determines that the medicines to be taken do not exist if any of the infrared signals is not detected.

14. The apparatus according to claim 12, wherein the medicine taking service unit determines that it is time for a user to take medicine if current time is included in a medicine-taking timing from the schedule and the concerned storage hole has the medicine therein.

15. The apparatus according to claim 12, wherein the medicine taking service unit determines that a user has not taken medicine if the current time is included between the medicine-taking timings from the schedule and the concerned storage hole has the medicine therein.

16. The apparatus according to claim 13, wherein the medicine taking service unit determines that a user should take medicines at a next medicine-taking timing if the current time is included between the medicine-taking timings from the schedule and the concerned storage hole does not have the medicine therein.

17. The apparatus according to claim 14, wherein the medicine taking service unit generates an alarm through a speaker to inform a user of the medicine-taking timing.

18. A method for supporting taking medicine of a medicine storage supporting apparatus, the method comprising:
receiving a preset schedule from a personal computer by synchronizing with the personal computer;
initializing a state of medicine storage holes if the schedule is received; and
performing a medicine service according to the schedule and the state of the medicine storage holes.

19. The method according to claim 18, wherein the receiving the preset schedule from the personal computer by synchronizing with the personal computer comprises:
changing into a standby mode if a synchronization condition is satisfied;
receiving the schedule from the personal computer;
analyzing data about the received schedule;
storing the analyzed data; and
receiving the schedule again from the personal computer if an error is generated from the analyzed data.

20. The method according to claim 18, wherein the initializing the state of the medicine storage holes comprises:
setting a state of a light emitting diode of the medicine storage holes into an OFF mode if the initialization condition is satisfied;
setting the state of the medicine storage holes into an EMPTY mode;
checking the state of the medicine storage holes; and
storing the state of the checked medicine storage holes.

21. The method according to claim 20, wherein the checking the state of the medicine storage holes comprises:
generating an infrared signal from a plurality of infrared ray generating sensors formed in the medicine storage holes;
checking whether at least one of the generated infrared signals is detected by a plurality of infrared ray receiving sensors formed in the medicine storage holes;
determining that the medicine storage holes have medicines therein if at least one infrared signal is detected; and
determining that the medicine storage holes do not have medicines therein if at least one infrared ray signal is not detected.

22. The method according to claim 21, further comprising determining an opening/closing of a cover through a contact sensor formed in the cover of the medicine storage holes.

23. The method according to claim 18, wherein the performing the medicine service comprises:
checking current time from the schedule and the pre-stored state of the medicine storage holes;
determining whether the medicine is taken, according to the determination result of current time; and
informing a user of the medicine service according to the determination result of whether the medicine is taken.

24. The method according to claim 23, wherein the determining whether the medicine is taken according to the determination result of current time comprises:
determining that it is time to take medicine if the current time is included in a medicine taking timing from the schedule and the medicine storage holes have the medicine therein;
determining that the medicine has not taken if the current time is included in the medicine-taking timing from the schedule and the medicine storage holes have the medicine therein; and
determining that the medicine should be taken at a subsequent medicine-taking timing if the current time is included between the medicine-taking timings from the schedule and the medicine storage holes do not have the medicine therein.
